(19) United States
(12) Patent Application Publication
(10) Pub. No.: US 2026/0185890 A1
(43) Pub. Date: Jul. 2, 2026

(54) DETECTING PASSING VALVE ACTIVITY IN PIPE SYSTEMS

(71) Applicant: Saudi Arabian Oil Company, Dhahran (SA)

(72) Inventors: Ali J. Alrasheed, Makkah (SA); Sahejad Patel, Thuwal (SA); Amjad Felemban, Makkah (SA); Siddharth Mishra, Dhahran (SA); Fadl Abdellatif, Thuwal (SA)

(21) Appl. No.: 19/008,426

(22) Filed: Jan. 2, 2025

(51) Int. Cl. G01M 3/24; F17D 5/06

(52) U.S. Cl. CPC G01M 3/24; F17D 5/06

(57) ABSTRACT

Systems and methods for detecting passing valves in pipe systems include receiving acoustic emission data from a set of piezoelectric sensors attached to a pipe with at least a first piezoelectric sensor of the set positioned upstream of a valve and at least a second piezoelectric sensor of the set positioned downstream of the valve. A data processing system filters the acoustic emission data using a bandpass filter, and extracts features from the filtered acoustic emission data. The extracted features include time-domain features, frequency domain features, or a combination thereof derived from statistical analysis of the filtered acoustic emission data. The data processing system predicts an operational state of the valve using a machine learning model that receives as input the extracted features and in response to predicting that the operational state of the valve is a passing valve, performs a corrective action.

### TECHNICAL FIELD

The present disclosure relates to methods and systems for detecting passing valves.

### BACKGROUND

Oil and gas plants include a multitude of pipes and valves to transport fluids throughout the plant. During normal operation, valves have an open position to enable fluid to flow through the pipes and a closed position to block fluid from flowing through the pipes. A passing valve, however, allows a portion of the fluid to pass the valve when the valve is in a closed position. Passing valves can be caused by human error in not closing a valve completely and/or due to degradation or damage to the valve.

Unintentional passing of gases to a flare system in oil and gas plants is a common issue that can result in significant business losses and environmental hazards. Gases that are produced during the oil and gas production processes are often burned off in the flare system to reduce the amount of gas that is released into the atmosphere. Passing valves can allow gases not meant to be burned in the flare system to be burned resulting in a significant loss of valuable resources. Unintentionally passing gases in the flaring system can pose environmental hazards. For example, the gases that escape into the atmosphere can contribute to air pollution that negatively impacts human health, wildlife, and the environment.

### SUMMARY

This disclosure describes systems and methods for detecting passing valves in pipe systems. A set of piezoelectric sensors can be attached to a pipe in a pipe system to detect acoustic emissions from a valve in the pipe system. One piezoelectric sensor of the set can be attached to pipe upstream from the valve, and another piezoelectric sensor of the set can be attached to the pipe downstream of the valve. A data processing system (e.g., a computer system or control system) can be communicatively coupled to the set of piezoelectric sensors. The data processing system can receive acoustic emission data from the set of piezoelectric sensors. The data processing system can filter the acoustic emission data using a bandpass filter. The data processing system can extract features from the filtered acoustic emission data using statistical techniques. The extracted features can include time domain features, frequency domain features, or both. The data processing system can predict an operational state of the valve using a trained machine learning model that receives the extracted features as input. In response to predicting that the operational state of the valve is a passing valve, the data processing system can perform a corrective action to resolve the passing valve.

Implementations of the systems and methods of this disclosure can provide various technical benefits. Using multiple piezoelectric sensors to detect passing valves can reduce the effects of noise caused by the external environment of the sensors relative to the effects of noise in measurements from a single sensor. Reducing the effects of noise in the acoustic emission data improves accuracy and reliability of the predictions. Having one piezoelectric sensor positioned upstream of a valve and a second piezoelectric sensor positioned downstream of the valve enables features related to the combination of data from the two sensors to be extracted from the acoustic emission data that are not possible using a single piezoelectric sensor. A machine learning model can be trained on features derived from the acoustic emission data from the multiple piezoelectric sensors to improve the accuracy of the prediction. For example, the machine learning model can be trained to predict valves in passing states based on differences between the acoustic emission data from the multiple piezoelectric sensors.

Using multiple piezoelectric sensors can reduce requirements for individual sensor calibration to the noise environment while providing accurate predictions as compared with a single sensor system because the environmental noise can be estimated and removed from the acoustic emission data based on the acoustic emission data from the multiple piezoelectric sensors. For example, based on the acoustic emission data from two or more piezoelectric sensors, the noise profile of the surrounding environment can be determined and compensated for in the acoustic emission data from the piezoelectric sensors without prior calibration. When changes occur in the environmental noise conditions, the two or more piezoelectric sensors can compensate for the changes without needing a recalibration as compared with a single sensor system that would need recalibration to compensate for the changed environment. The piezoelectric sensors can detect passing valves based on frequencies greater than the human audible range.

Further, the piezoelectric sensors are external to the pipe, independent of pressure sensors or flow sensors, and do not intrude into the pipe. The piezoelectric sensors can detect passing valves automatically to enable early mitigation of the passing valves. The piezoelectric sensors can be coupled to many sizes of pipes providing adaptability for different environments.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 is a block diagram of an example system for detecting passing valves in pipe systems.

FIGS. 2A, 2B, and 2C illustrate example configurations of systems including two piezoelectric sensors near a valve in a pipe system.

FIGS. 3A, 3B, and 3C illustrate example configurations of systems including three or more piezoelectric sensors on and near a valve in a pipe system.

FIG. 4 is an example workflow for detecting passing valves in a pipe system using a set of piezoelectric sensors.

FIG. 5 is an exploded view of an example piezoelectric sensor device for detecting passing valves in pipe systems.

FIG. 6 is a flowchart of an example method for detecting passing valves.

FIG. 7 is a schematic illustration of an example testing device for generating training data to train a machine learning model to detect passing valves.

FIG. 8 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Valves that behave as passing valves (e.g., closed valves that do not completely block the passage of fluids) can occur, for example, in the energy industry such as in oil and gas plants where an abundance of pipes and valves are used. Valves can become passing valves as a result of human error (e.g., not fully closing the valve) and/or by a fault within the valve (e.g., degradation of valve components or damage to the valve). Leakages caused by passing valves can be costly for the environment, operator health, and business finances. For example, oil or gas leaks can contaminate the environment by releasing greenhouse gases, cause injury or disease to employees, and waste sellable assets.

This disclosure describes systems and methods for detecting when valves behave as passing valves in pipe systems. A set of piezoelectric sensors can be configured to couple to a pipe near a valve. At least one piezoelectric sensor of the set can be coupled to the pipe upstream of the valve, and at least another piezoelectric sensor can be coupled to the pipe downstream of the valve. Acoustic waves emitted by a passing valve can cause the downstream signal to have different characteristics than the upstream signal. Using both the downstream and upstream acoustic emission data can identify features that indicate that a valve is in a passing state. The set of piezoelectric sensors are communicatively coupled to a data processing system. The data processing system receives acoustic emission data from the set of piezoelectric sensors, filters the acoustic emission data, extracts features from the acoustic emission data, and predicts an operational state of the valve using a trained machine learning model that receives the extracted features as inputs.

The set of piezoelectric sensors can be coupled to a variety of pipe sizes and types. Because the set of piezoelectric sensors do not protrude into the pipe, the set of piezoelectric sensors provide flexibility in installing the set of piezoelectric sensors near valves. For example, sets of piezoelectric sensors can be installed on a multitude of valves within a complex pipe system (e.g., in an oil or gas plant) to provide monitoring of the valve conditions without having to modify existing piping to introduce flow or pressure sensors that interface with the fluid within the pipes.

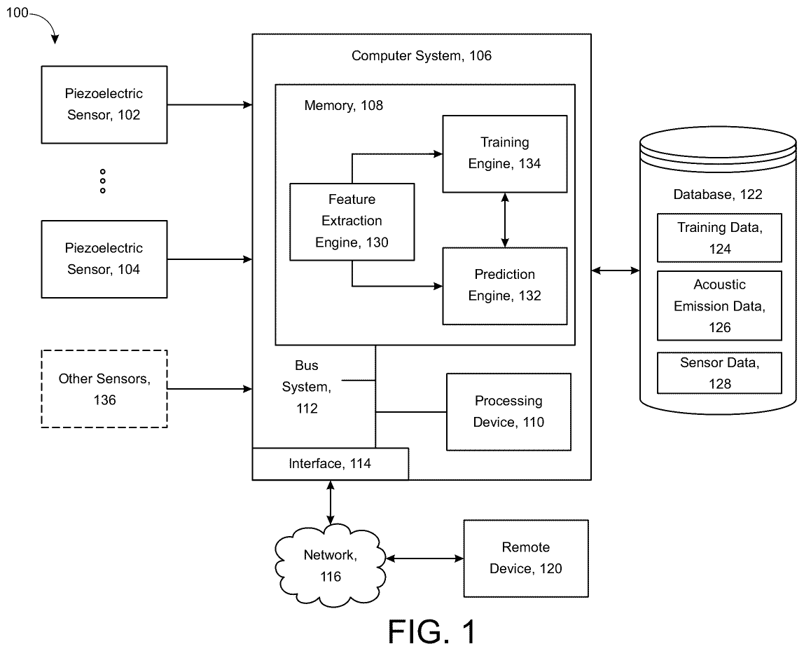

FIG. 1 is a block diagram of an example system 100 including multiple piezoelectric sensors 102, 104 communicatively coupled to a computer system 106. The piezoelectric sensors are configured to couple to a pipe near a valve with one piezoelectric sensor (e.g., piezoelectric sensor 102) positioned upstream of the valve, and a second piezoelectric sensor (e.g., piezoelectric sensor 104) positioned downstream of the valve. The system 100 can include more than two piezoelectric sensors.

The computer system 106 includes a memory 108, processing device 110, bus system 112, and interface 114. The memory 108 includes a feature extraction engine 130, a prediction engine 132, and a training engine 134. The computer system 106 can connect to a remote device 120 (e.g., to transmit or receive data) through a network 116. The network 116 can be a wired or wireless network. The computer system 106 is also communicatively coupled to a database 122. The database 122 can include data such as training data 124, acoustic emission data 126, and sensor data 128. The training data 124 includes features extracted from acoustic emission data 126 and labeled with a correct state of the valve (passing or not passing). The acoustic emission data 126 includes time-series data collected from piezoelectric sensors (e.g., piezoelectric sensors 102, 104). The acoustic emission data 126 can be stored as data indicating an amplitude of the acoustic emission at an associated time. In some implementations, the acoustic emission data 126 includes a frequency domain representation of the acoustic signals. For example, the acoustic emission data 126 can include frequencies identified in the acoustic signal and the magnitude of the identified frequencies. The sensor data 128 includes data from other types of sensors such as temperature data, pressure data, fluid velocity data, etc. The sensor data 128 can include time-series data and/or average values.

The feature extraction engine 130 receives acoustic emission data from the piezoelectric sensor 102, 104 and extracts features from the acoustic emission data using statistical techniques. The features extracted by the feature extraction engine 130 are sent to the prediction engine 132 to predict an operational state of a valve. The features extracted by the feature extraction engine 130 can also be sent to the training engine 134 to form a training dataset to train the prediction engine 132.

The feature extraction engine 130 extracts time domain features and/or frequency domain features. Time domain features include, for example, a root mean square (RMS) of the acoustic emission data that give a measure of the magnitude of the signal and zero-crossing rate which counts the number of times that the acoustic emission data changes from a positive value to a negative value or vice versa. Frequency domain features can include, for example, spectral roll-off, spectral bandwidth, frequency with maximum amplitude, frequency with maximum time averaged amplitude, and Mel-Frequency Cepstral Coefficients (MFCCs). Spectral roll off is a measure of the shape of the power spectrum of the acoustic emission data. In particular, it measures the frequency at which high frequencies decline to zero. Spectral Bandwidth is a weighted mean of the distances of frequency bands form the spectral centroid. Frequency value with maximum amplitude and frequency value with maximum time-average amplitude can be determined based on a spectrogram representing the acoustic emission data. MFCCs give short-term power spectrum of the signal, which can be useful to distinguish acoustic emission data having different frequency content (e.g., passing and closed valves). For example, 5-20 MFCC coefficients can be extracted.

In an example implementation, the feature extraction engine 130 extracts 27 features (20 MFCC coefficients, RMS, zero crossing rate, spectral centroid, roll off, and 3 bandwidths) from the acoustic emission data. More or fewer features can be extracted from the acoustic emission data. The number of features extracted can depend on the raw input data and the performance of a machine learning model trained on the features. In this example, the data processing system transforms the 200,000 inputs from the raw acoustic emission data into 27 input features which can increase the performance, the speed, and the efficiency of the prediction engine 132 compared to processing the raw acoustic emission data.

The feature extraction engine 130 can also transform extracted features to reduce the dimensionality of the input to the prediction engine 132. For example, the feature extraction engine 130 can perform a principal components analysis (PCA) to determine the most significant features (e.g., features having the largest impact on the prediction generated by the prediction engine 132) to send as input to the prediction engine 132. A feature having more significance can have a higher reduction in the percentage of results classified correctly when the feature is omitted relative to the reduction in the percentage of results classified correctly when other features are omitted.

The feature extraction engine 130 can extract features based on acoustic emission data from both piezoelectric sensors 102, 104. The feature extraction engine 130 can extract amplitude based features, frequency based features, cross correlations, other statistical features, and/or waveform shape features.

Amplitude-based features are extracted by comparing the amplitudes of the signals captured by the upstream and downstream piezoelectric sensors 102, 104. Example amplitude based features include amplitude difference, the ratio of amplitudes, or the average value between the two signals. Amplitude based features are useful to help identify variations or abnormalities caused by the passing valve.

Frequency-based features are extracted by analyzing the frequency content of the signals from both piezoelectric sensors 102, 104 using techniques such as Fourier transforms or wavelet transforms. Example frequency-based features include dominant frequencies, frequency ratios, or spectral energy distribution. Frequency-based features can provide information about the characteristic frequencies associated with passing valves.

Cross-correlation features are extracted by determining the cross-correlation between the signals from the upstream and downstream piezoelectric sensors 102, 104. Cross-correlations measure the similarity between two signals at different time lags. By finding the time lag at which the cross-correlation is maximized, the time delay between the two signals is determined, which can be indicative of a passing valve.

Other statistical features are extracted by determining descriptive statistical measures such as mean, standard deviation, skewness, or kurtosis for the signals from both piezoelectric sensors 102, 104. These other statistical features can capture the distribution and variation of the acoustic emission data, which can be used to identify anomalies caused by the passing valve.

Waveform shape features are extracted by determining shape-related features such as rise time, fall time, peak width, or zero-crossing count. The waveform shape features can provide insights into the temporal characteristics of the signals, which can be used to differentiate between normal and passing valve events.

In some implementations, the feature extraction engine 130 can generate a spectrogram based on the acoustic emission data. A spectrogram, for example, represents time variation of the frequency content of a measured signal. A spectrogram can be a two-dimensional image with the vertical axis representing frequency, the horizontal axis representing time and the image grayscale intensity or color values of the pixels in the image can represent the amplitude of the measured signal at the corresponding frequency and time. Including the time variation can decrease the effects of noise on the signal since external noise can be a shorter duration than the signal length. The external noise would therefore not affect each time step of the acoustic emission data and the spectrogram. Including the time variation of the signal can give the model more discriminatory power as compared with a power spectral density without time variation.

In some implementations, the feature extraction engine 130 generates spectrograms based on a 100 millisecond (ms) sample of acoustic emission data. The data processing system can generate the spectrograms by apply a sliding window of Fast Fourier Transforms (FFTs). The length of each window can be, for example, 256 samples and there can be an overlap, e.g., 50% overlap, between windows. The length of each window and the overlap between windows are parameters that can be tuned to generate spectrograms with desired frequency resolution and/or desired time resolution. For example, increasing the number of samples per window can increase the frequency resolution in the spectrogram while decreasing the temporal resolution. The temporal resolution can be increased or decreased by changing the window overlap, e.g., a larger overlap will increase the temporal resolution and a smaller overlap will decrease the temporal resolution.

The feature extraction engine 130 can process the acoustic emission data to reduce noise and/or isolate frequencies outside a desired range. For example, the feature extraction engine 130 can apply a bandpass filter to the acoustic emission data. The bandpass filter attenuates frequencies outside of a specified band to isolate frequencies indicative of passing valves (e.g., 50-500 kilo Hertz (kHz), 100-300 kHz, 20-500 kHz). The lower frequency limit can be specified, for example, to attenuate anticipated low frequency noise such as noise from vibrations or sounds caused by operating machinery or sounds in the human audible range. The upper limit of the frequency range can be selected, for example, based on the sampling frequency of the piezoelectric sensors 102, 104 or a multiple of a known peak frequency in the acoustic emission data.

In some implementations, the piezoelectric sensors 102, 104 are analog sensors, and the bandpass filter is an analog bandpass filter applied before digitization of the signal from the sensor. In some implementations, the bandpass filter is applied by the computer system 106 after the signal has been converted from an analog signal to a digital signal.

The computer system 106 can convert an analog signal from the piezoelectric sensor(s) 102, 104 to a digital signal using a high-sampling rate analog to digital converter (ADC). The sampling rate of the ADC can be sufficiently high to satisfy the Nyquist criterion based on an anticipated maximum frequency to be measured. For example, fluids leaking past a passing valve can generate frequency peaks around 150 kHz. In this example, a sampling rate of at least 300 kHz can be used to detect the 150 kHz frequency. Higher sampling rates (e.g., 500 kHz or more, 1 MHz or more, 2 MHz or more) can be used to further resolve the desired frequencies. In contrast, closed valves (e.g., not passing) generate uniform frequency spectra (e.g., without distinct peaks) in the frequency range of 20-500 kHz.

The prediction engine 132 includes a machine learning model used to predict an operational state of a valve. The prediction engine 132 processes the features selected during feature extraction and outputs a binary classification (e.g., 0 for a closed valve and 1 for a passing valve). Input to machine learning model in the prediction engine 132 includes the extracted features. The machine learning model can be, for example, a random forest model, a k-nearest neighbors model, an artificial neural network (ANN), a support vector machine (SVM), an XGBoost model, or a convolutional neural network (CNN).

In some implementations, the output of the prediction engine 132 can be a probability of the valve being a passing valve (e.g., by using regression models). The probability output by the machine learning model can also be used to determine a health of the valve. For example, a low probability (e.g., less than 10%, less than 20%, less than 30%) can indicate a healthy valve. A moderately low probability (e.g., between 10% and 50%, between 20% and 60%, between 30% and 70%) can indicate a deteriorating valve. Higher probabilities (e.g., greater than 50%, greater than 60%, greater than 70%) can indicate the valve is failing (e.g., passing fluids).

The machine learning model in the prediction engine 132 is trained by the training engine 134. Training data for the machine learning model can include acoustic emission data collected from a testing device having multiple valve types and pipe diameters. The training engine 134 can access training data 124 from the database 122. The training data 124 can be divided between a training set and a test set. For example, data collected from ball valves and gate valves can form the training set and data from globe valves can form the test set. The training data can be divided between the training set and the test set in other ways also. For example, the training set and the test set can be selected randomly from the training data according to a specified ratio (e.g., 70/30 training/testing split). The data processing system optimizes the machine learning model based on the training set. The data processing system evaluates the machine learning model performance based on the test set.

System 100 can include other sensors 136. The other sensors 136 can include temperature sensors, pressure sensors, flow rate sensors, magnetic sensors, etc. The feature extraction engine 130 can receive data from the other sensors 136 to generate additional features that can be sent to the prediction engine 132. For example, the data from the other sensors 136 can be single digit features that are added to the input features (e.g., extracted features) used by the machine learning model in the prediction engine. The computer system 106 can also store the data from the other sensors 136 in the database 122 as sensor data 128 to be accessed at a later time.

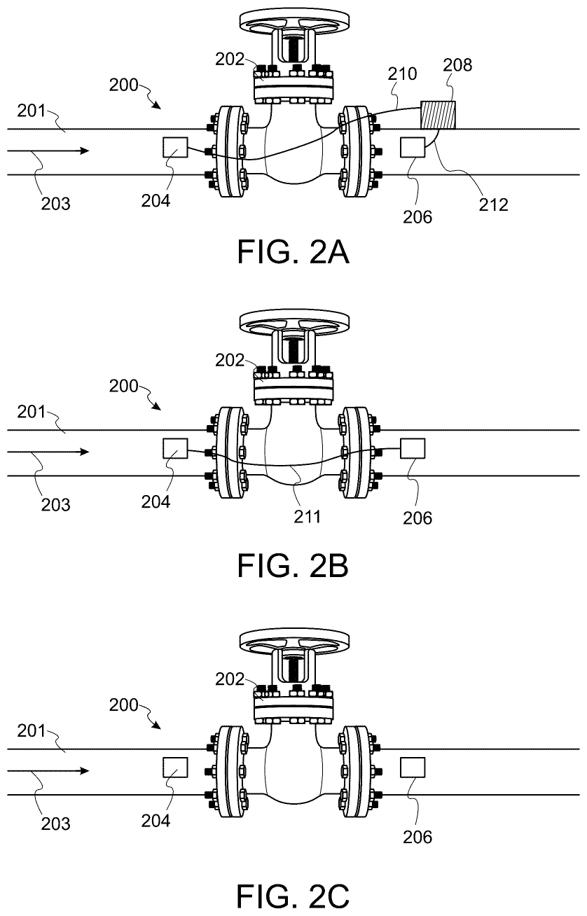

FIGS. 2A, 2B, and 2C illustrate example configurations for a system 200 for detecting passing valves in a pipe system. The system 200 includes two piezoelectric sensors 204, 206. The two piezoelectric sensors 204, 206 are coupled to the pipe 201 on either side of the valve 202. The flow direction 203 as illustrated is from left to right. Comparing the signals of the two piezoelectric sensors 204, 206 can reveal the status of the valve 202. For example, if both signals are very similar in features, it can indicate that the valve 202 is completely closed, and there is nothing passing through the valve. However, if the signal from the downstream piezoelectric sensor 206 is much stronger (e.g., higher amplitude or higher frequency) than the signal from the upstream piezoelectric sensor 204, it can indicate the valve 202 is passing. An advantage of using multiple sensors is a reduction in the effects of external noise or vibration nearby the pipeline. This is a result of both sensors experiencing the same noise and vibration.

In FIG. 2A, the first piezoelectric sensor 204 is coupled to the pipe 201 upstream of the valve 202, and the second piezoelectric sensor 206 is coupled to the pipe 201 downstream of the valve 202. The piezoelectric sensors 204, 206 are both communicatively coupled to a central processing unit 208 through cables 210, 212. The central processing unit 208 is coupled to the pipe 201 downstream from the valve 202. The central processing unit 208 receives and processes acoustic emission data from the piezoelectric sensors 204, 206. The central processing unit 208 also predicts the operational state of the valve 202 using a trained machine learning model. Alternatively, or additionally, the central processing unit transmits the acoustic emission data to a data processing system in a remote location (e.g., a control room or data processing center) over a wireless network (e.g., Wi-Fi, cellular, short range radio communications).

In FIG. 2B, the piezoelectric sensors 204, 206 are connected to one another by cable 211. Either, or both, of piezoelectric sensors 204, 206 include an onboard computer that can receive, process, and transmit the acoustic emission data from the piezoelectric sensors 204, 206.

In FIG. 2C, the piezoelectric sensors 204, 206 are wirelessly coupled. The piezoelectric sensors 204, 206 include wireless communications modules to transmit and receive data over a wireless connection. The piezoelectric sensors 204, 206 can communicate with each other, and/or with remote computing devices.

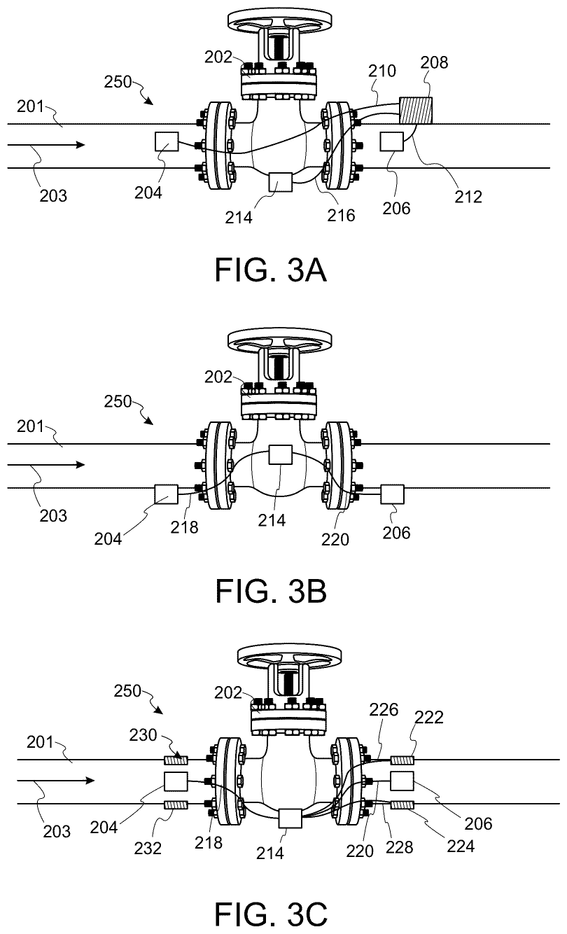

FIGS. 3A, 3B, and 3C illustrate example configurations for a system 250 that includes three or more piezoelectric sensors. System 250 is substantially similar to the system 200 with one or more additional piezoelectric sensors added. Both systems 200, 250 can include variable numbers of piezoelectric sensors depending on the requirements of the implementation and available equipment. Placing a piezoelectric sensor 214 directly on the valve 202, in addition to the upstream and downstream piezoelectric sensors 204, 206, can capture the pressure waves generated by the valve 202 itself. Combined with the acoustic emission data from the upstream and downstream piezoelectric sensors 204, 206, the acoustic emission data from piezoelectric sensor 214 coupled to the valve 202 can improve the accuracy of the prediction of the operational state of the valve 202.

In FIG. 3A, piezoelectric sensor 204 is coupled to the pipe 201 upstream from the valve 202, piezoelectric sensor 206 is coupled to the pipe 201 downstream from the valve 202, and piezoelectric sensor 214 is coupled to the bottom of the valve 202. The piezoelectric sensors 204, 206, 214 are each coupled to the central processing unit 208 through cables 210, 212, 216, respectively.

In FIG. 3B, piezoelectric sensors 204, 206 are coupled to the bottom of the pipe 201, and piezoelectric sensor 214 is coupled to the side of the valve 202. In this example, the piezoelectric sensor 204 is coupled to the piezoelectric sensor 214 through cable 218. The piezoelectric sensor 206 is coupled to the piezoelectric sensor 214 through cable 220. One or more of the piezoelectric sensors 204, 206, 214 include a data processing system for receiving, processing, and transmitting the acoustic emission data and predicted operational state of the valve 202.

FIG. 3C illustrates the system 250 with seven piezoelectric sensors 204, 206, 214, 222, 224, 230, 232. Piezoelectric sensors 204, 230, 232 are coupled to the pipe 201 upstream of the valve 202. The piezoelectric sensors 204, 230, 232 can be evenly distributed around the circumference of the pipe 201 near the valve 202. Piezoelectric sensor 204 is coupled to piezoelectric sensor 214 through cable 218. Piezoelectric sensors 230, 232 are coupled to piezoelectric sensor 214 and/or other ones of the piezoelectric sensors 204, 206, 222, 224 wirelessly. Piezoelectric sensor 214 is coupled to the bottom of the valve 202. Piezoelectric sensors 206, 222, 224 are coupled to the pipe 201 downstream of the valve 202. The piezoelectric sensors 206, 222, 224 can be evenly distributed around the circumference of the pipe 201. Each of piezoelectric sensors 206, 222, 224 is coupled to the piezoelectric sensor 214 through a respective cable 220, 226, 228.

The systems 200, 250 can include any reasonable number of piezoelectric sensors connected through wired or wireless connections to one another. The positioning of the piezoelectric sensors in relation to the valve or pipe structure can depend on the type of valve, its operational requirements, and the specific measurement needs. For example, a gate valve, a ball valve, and a globe valve can each emit acoustic waves from different locations within the valve, and the piezoelectric sensors can be positioned on and/or around the valves in positions to best capture the acoustic emissions. Depending on the type of valve, the location within the valve where turbulence is maximized can be different. The locations of maximum turbulence generate strong acoustic emissions. The piezoelectric sensors can be positioned on the valves to measure the acoustic emissions from the maximum turbulence.

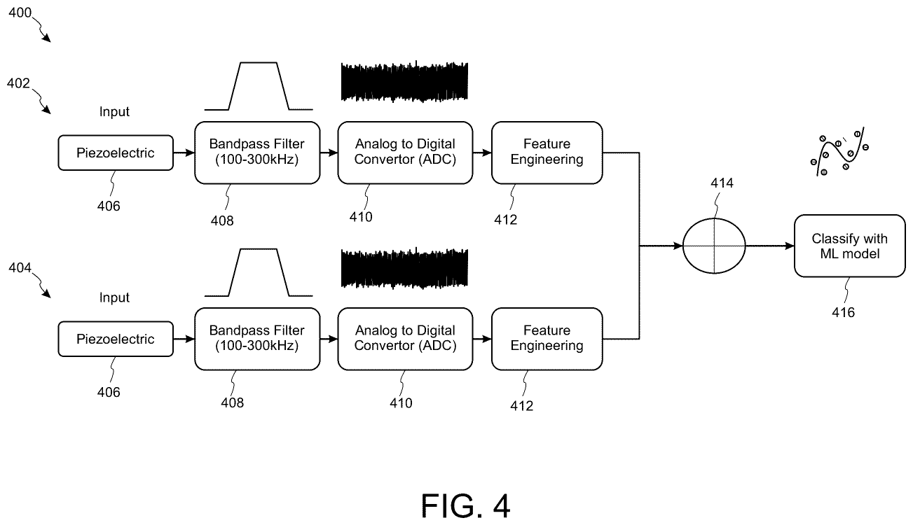

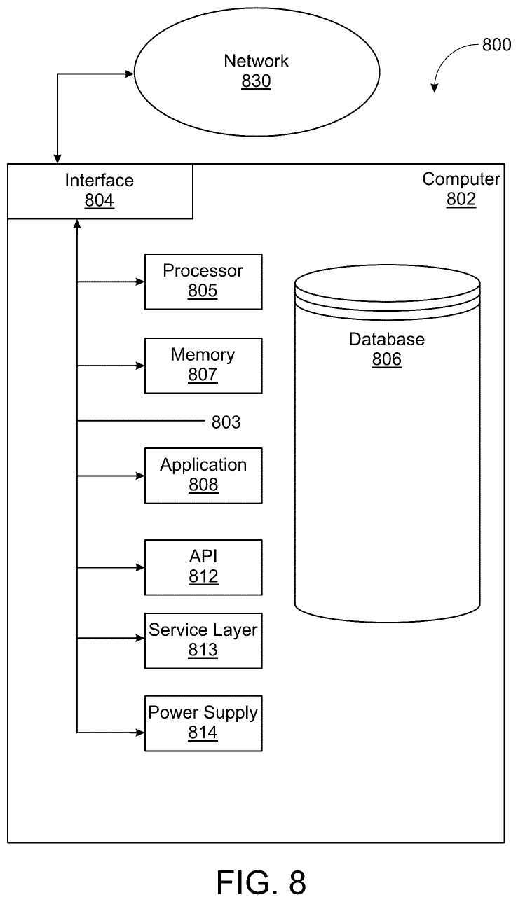

FIG. 4 is a workflow of a process 400 for detecting a passing valve in a pipe system. The process 400 can be implemented on a data processing system (e.g., computer system 106, onboard computer system 512, or the computer system of FIG. 8). The process 400 includes processing branches 402, 404 for each piezoelectric sensor associated with a valve in a pipe system. The process 400 is illustrated as using two piezoelectric sensors, but the process can be used with more or fewer of piezoelectric sensors by adding or removing additional processing branches. Acoustic emission data is processed using similar processing steps for each piezoelectric sensor.

The data processing system receives 406 acoustic emission data from the piezoelectric sensors. One piezoelectric sensor can be positioned upstream of the valve and one piezoelectric sensor can be positioned downstream of the valve.

The data processing system filters 408 the acoustic emission data using a bandpass filter. For analog piezoelectric sensors the bandpass filter can be applied as a hardware filter in the data processing system. Example ranges of frequencies passed by the bandpass filter include 50-500 kHz, 100-300 kHz, etc. The data processing system converts 410 the analog signals to digital signals using an ADC. The ADC samples the analog signal at discrete times to form a digital signal. The ADC can sample the acoustic emission data at a rate commensurate with the maximum frequency that is desired to be resolved. For example, the ADC can sample the acoustic emission data at 1 MHz or 2 MHz. Alternatively, the data processing system filters 408 the acoustic emission data using a digital bandpass filter applied to digital acoustic emission data.

The data processing system extracts 412 features from the acoustic emission data using feature engineering. The extracted features include time domain and frequency domain features extracted with statistical techniques. For example, the data processing system uses the feature extraction engine 130 to extract the features.

The data processing system combines 414 the extracted features from each of the piezoelectric sensors. For example, the data processing system can add, subtract, and/or concatenate the features to form a single set of input features for the machine learning model. Combining features can improve the optimization of the machine learning model if the dataset (e.g., number of features) is small. Concatenating the features from the multiple piezoelectric sensors can increase the number of features for large datasets that can improve the machine learning model performance.

The data processing system can use data fusion techniques to combine the extracted features. For example, the data processing system can use weighted averaging, decision-level fusion, feature-level fusion, and/or Dempster-Shafer theory to fuse the data from the multiple piezoelectric sensors.

In weighted averaging, the data processing system combines the extracted features by assigning weights to the features based on metrics (e.g., reliability, relevance, etc.). Weighted averaging fuses the extracted features according to the relative contribution of each sensor. For example, the features from the piezoelectric sensor positioned downstream of the valve can be assigned higher weights than the features from the piezoelectric sensor positioned upstream of the valve because the features from the downstream piezoelectric sensor can have a higher relevance to the prediction of the operational state of the valve.

In decision level fusion, the data processing system determines a prediction of the state of the valve (e.g., using the machine learning model, prediction engine 132) based on the data from each piezoelectric sensor separately (e.g., for two piezoelectric sensors, two predictions are generated, one for each piezoelectric sensor). The data processing system combines the individual predictions to form a collective prediction using logical operations (e.g., voting) or averaging.

In feature level fusion, the data processing system combines the extracted features from each sensor to create a single feature set to be used as input for machine learning or statistical modeling.

In Dempster-Shafer theory, the data processing system combines belief functions from individual sensors to generate a fused belief function. Belief functions represent uncertainty by combining evidence from different sources (e.g., multiple sensors).

The data processing system predicts an operational state of the valve by classifying 416 the valve using a machine learning model where the extracted features are inputs to the machine learning model. Example operational states include passing or not passing that can be represented by a binary classification. In some implementations, the machine learning model produces a probability associated with the predicted operational state.

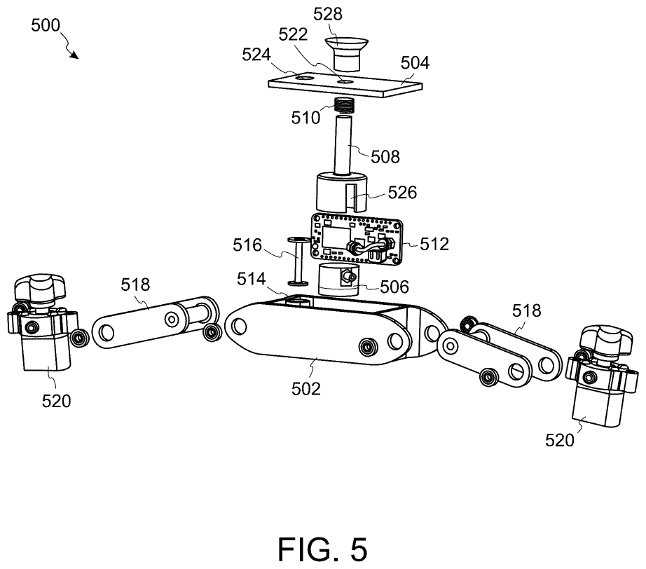

FIG. 5 is an exploded view of an example sensor device 500 for detecting passing valves in a pipe system. The sensor device 500 can be included in the system 100 (e.g., piezoelectric sensor 102, 104). The sensor device 500 can be attached to a pipe near a valve or on a valve to measure acoustic emissions from the valve. The sensor device 500 can be fitted to a variety of pipe sizes and materials. The sensor device 500 can have multiple sensor channels to enable electronic communication among a set of sensor devices attached to a pipe upstream of a valve, downstream of a valve, or on the valve. Multiple sensor devices can improve the passing detections or overall valve condition monitoring. The set of piezoelectric sensors can be communicatively coupled to a single sensor device 500. Alternatively, or additionally, the set of piezoelectric sensors can be communicatively coupled to an external computing device co-located with the set of piezoelectric sensors or remote from the set of piezoelectric sensors.

The sensor device 500 includes a housing 502. The housing 502 provides protection for a piezoelectric sensor 506 and an onboard computer system 512. The housing 502 can also provide acoustic dampening, reducing noise detected by the piezoelectric sensor 506 from disturbances or ambient noises in the operating environment. A cover plate 504 is coupled to a first side 530 of the housing 502. For example, the cover plate 504 can be coupled to the housing 502 by bolts, screws, rivets, etc.

The piezoelectric sensor 506 is positioned within the housing 502. The piezoelectric sensor 506 is configured to detect acoustic emissions (e.g., sound data and/or vibrational data) from a pipe to which the sensor device 500 is in contact. The piezoelectric sensor 506 is held in place by a sensor holder 508. The sensor holder 508 includes a recess 526 that is sized to receive the piezoelectric sensor 506. The recess 526 can be sized to have a snug fit with the piezoelectric sensor 506 such that the piezoelectric sensor 506 is held in place within the recess 526. The end of the sensor holder 508 with the recess 526 can have a larger diameter than a middle portion of the sensor holder 508. A handle 528 is attached to the sensor holder 508 on the end of the sensor holder 508 opposite the recess 526. The sensor holder 508 protrudes through an opening 522 in the cover plate 504 enabling adjustment of the piezoelectric sensor 506 when the cover plate 504 is attached to the housing 502.

A spring 510 is positioned around a portion of the sensor holder 508 (e.g., the middle portion) between the recess 526 and the cover plate 504. The spring 510 is configured to bias the sensor holder away from the cover plate 504 and toward the second side 532 of the housing 502 opposite the first side 530. The sensor holder 508 and the spring 510 enable the piezoelectric sensor 506 to be held in place while performing measurements. The sensor holder 508 and spring 510 also enable adjustment of the height of the piezoelectric sensor 506 relative to the pipe, for example, to inject a couplant fluid between the piezoelectric sensor 506 and the pipe.

The housing 502 also includes a syringe 514. The syringe 514 is configured to hold a couplant fluid to be injected between the piezoelectric sensor 508 and the pipe. A plunger rod 516 ejects the couplant fluid in the syringe 514 when the plunger rod 516 is depressed. The plunger rod 516 protrudes through an opening 524 in the cover plate 504 enabling the plunger rod 516 to be depressed when the housing 502 and the cover plate 504 are assembled. The couplant fluid can be a fluid that facilitates transmission of acoustic waves from the pipe to the piezoelectric sensor 506 to improve the accuracy of measurements of the acoustic emission data by the piezoelectric sensor 506. Examples of couplant fluids include water, oil, grease, gels, etc.

The sensor device 500 includes hinged arms 518 that connect magnets 520 to the housing 502. The hinged arms 518 are rotatably coupled to the housing 502 at one end and the magnets 520 at the opposite end. As shown in FIG. 5, the hinged arms 518 use pin joints to connect to the housing 502 and the magnets 520. The hinged arms 518 enable the sensor device 500 to be coupled to a variety of different pipe diameters. The housing 502 can be held in contact with a pipe wall by adjusting the hinged arms 518 and the magnets 520. In some implementations, the hinged arms 518 include slots that enable the effective length of the hinged arms 518 to be adjusted. For example, the hinged arm can have a slot along the length of the hinged arm that allows the distance between the magnets 520 and the housing 502 to be adjusted by sliding the magnets 520 or the housing 502 closer to each other in the slot. In some implementations, the magnets 520 are switchable magnets. In some implementations, the sensor device 500 is coupled to the pipe using a band or tie that wraps around the pipe.

The onboard computer system 512 can be, for example, a printed circuit board (PCB) with one or more processors, a computer-readable storage medium storing instructions, and circuitry for processing and conditioning signals from the piezoelectric sensor 506. The onboard computer system 512 is configured to detect the state of the valve in real-time using a trained machine learning model. The onboard computer system 512 can include electronic circuits for processing, conditioning, networking and inferring valve conditions. Various valve conditions can be monitored such as passing, not passing or quantification of product flowing through the valve by utilizing machine learning models.

The onboard computer system 512 includes wireless communication hardware to facilitate transmission of acoustic emission data, the state of the valve, and/or predictions of valve performance. For example, the onboard computer system 512 can include a transceiver to transmit and receive wireless communication signals over wireless networks (e.g., Wi-Fi, wireless local area networks (WLAN)), cellular networks, and/or using short range radio communications. In some implementations, the onboard computer system 512 includes a high range, low energy transmission module to send data wirelessly over long distances where conventional wireless networks are not available.

In some implementations, the onboard computer system 512 includes additional sensors (e.g., other sensors 136, accelerometers, temperature sensors, magnetometers etc.) that can be used to improve the accuracy of predictions for valve performance. For example, the data from the additional sensors can reduce the number of false positive or negative predictions improving reliability of the predictions by the sensor device 500. The machine learning model can be trained using data from the piezoelectric sensor and the additional sensor allowing for more complex insights and analysis. In some implementations, the onboard computer system 512 can update model parameters of the trained machine learning model using signals received from the piezoelectric sensor 506 and/or the additional sensors.

The sensor device 500 can operate on battery power for standalone applications, employing energy-efficient components and power management strategies to extend battery life, e.g., sleep mode. Alternatively, if the inspected valve is not a manual valve, the sensor device 500 can be powered by the actuator power of the valve (or any other nearby source), removing complications resulting from powering the device. These power source options can make the device easy to be deployed across the facility for extended periods of time.

Real-time or near real-time processing and/or communication refers to a scenario in which received data (e.g., acoustic emission data) are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time communication system is configured to process acoustic emission data as it arrives and determine if the valve is a passing valve as quickly as possible (though processing latency may occur). Though data can be buffered between module interfaces in a pipelined architecture, each individual module operates on the most recent data available to it. The overall result is a workflow that, in a real-time context, receives a data stream (e.g., acoustic emission data) and outputs processed data (e.g., valve classification) based on that data stream in a first-in, first out manner. However, non-real-time contexts are also possible, in which data are stored (either in memory or persistently) for processing at a later time. In this context, modules of the data processing system do not necessarily operate on the most recent data available.

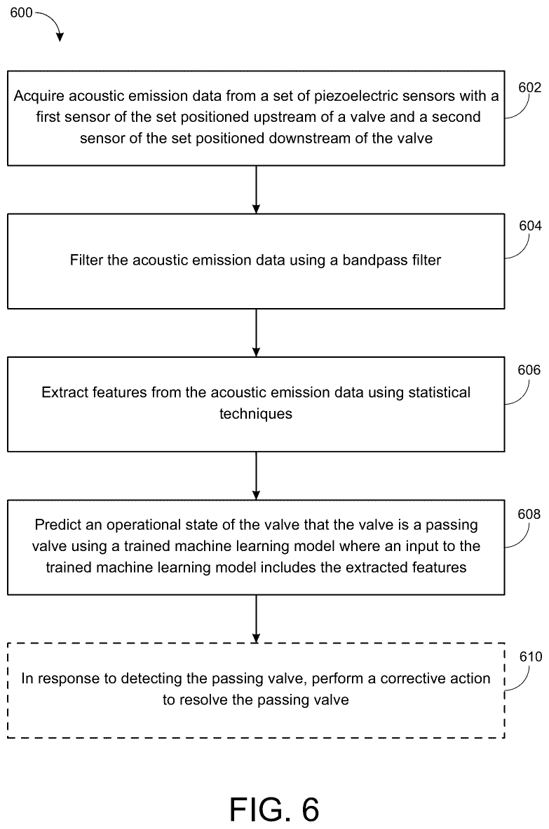

FIG. 6 is a flow chart for an example method 600 for detecting passing valves in a pipe system. The method 600 can be implemented on a data processing system such as a computer or control system (e.g., computer system 106, computer system 512). In some examples, the method 600 is implemented on one or more processors included in a sensor device (e.g., sensor devices 500) attached to a pipe, thereby enabling the method to be executed on-the-edge (e.g., near the point of data collection). In other examples, the data processing system is separate from the sensor device.

The data processing system receives acoustic emission data from a set of piezoelectric sensors attached to a pipe with at least a first piezoelectric sensor of the set positioned upstream of a valve and at least a second piezoelectric sensor of the set positioned downstream of the valve (step 602). The piezoelectric sensors can include integrated electronics to measure the acoustic emissions and process the measured data without communicating with a computing system external to the sensor and its associated electronics. The piezoelectric sensors can be coupled to a pipe near a valve of interest. For example, the sensor can be attached to a pipe with magnets at a location on the downstream side of a valve. Magnetically attaching the sensor to the pipe can enhance the acoustic emission readings by reducing measurements of ambient noise. The sensor can be sensitive to vibrations from the valve. In implementations having non-magnetic pipes, the sensor can be coupled to the pipe through other means such as clamps, bolts, and/or zip-ties. The sensors can be communicatively coupled with other computing devices to transmit and receive data such as passing valve detection alerts and sensor status. In some implementations, the data processing system acquires the acoustic emission data from a data store storing data previously acquired from a piezoelectric sensor.

The data processing system filters the acoustic emission data using a bandpass filter (step 604). For example, the bandpass filter passes frequencies between 100 kHz and 300 kHz.

The data processing system extracts features from the filtered acoustic emission data (step 606). The extracted features include time-domain features, frequency domain features, or a combination thereof derived from statistical analysis of the filtered acoustic emission data. For example, features can include one or more of a root mean square value, a spectral roll off, a spectral bandwidth, a zero-crossing rate, and Mel-Frequency Cepstral Coefficients determined from the acoustic emission data.

In some implementations, the data processing system extracts features from the acoustic emission data for each piezoelectric sensor of the set of piezoelectric sensors separately. The data processing system combines the extracted features from each piezoelectric sensor of the set into a single set of extracted features.

In some implementations, the data processing system combines acoustic emission data from the set of piezoelectric sensors using a weighted average where acoustic emission data from the piezoelectric sensor positioned downstream of the valve receives a higher weight than acoustic emission data from the piezoelectric sensor positioned upstream of the valve.

In some implementations, the data processing system extracts features from the acoustic emission data by performing a cross correlation between acoustic emission data from the piezoelectric sensor positioned upstream of the valve and acoustic emission data from the piezoelectric sensor positioned downstream of the valve.

The data processing system predicts an operational state of the valve using a machine learning model that receives as input the extracted features (step 608). In some implementations, the data processing system generates predictions using the trained machine learning model to predict the operational state of the valve based on the acoustic emission data from each piezoelectric sensor of the set separately; and the data processing system combines the predictions to form a collective prediction of the operational state of the valve.

In response to predicting the operational state of the valve is a passing valve, the data processing system performs a corrective action to resolve the passing valve (step 610). Resolving the passing valve includes inhibiting or stopping fluid from flowing through the passing valve. In some implementations, the data processing system performs a corrective action including generating an alert indicating the detection of the passing valve. For example, the data processing system can generate an audible alert and/or a visual alert at the location of the passing valve. Alternatively, or additionally, the data processing system can transmit a signal to a computing device (e.g., a mobile device) that includes a display device to display an alert indicating that a passing valve was detected.

In some implementations, the data processing system performs a corrective action including generating a signal to automatically close a valve upstream of the detected passing valve. For example, the data processing system can generate a control signal to electronically close a valve located upstream of the detected passing valve to prevent leaks through the passing valve.

In some implementations, the data processing system acquires training data for the machine learning model by acquiring acoustic emission data associated with passing valves and non-passing valves from a testing device, the acoustic emission data associated with multiple valve types and multiple pipe diameters. The data processing system trains the machine learning model using the training data.

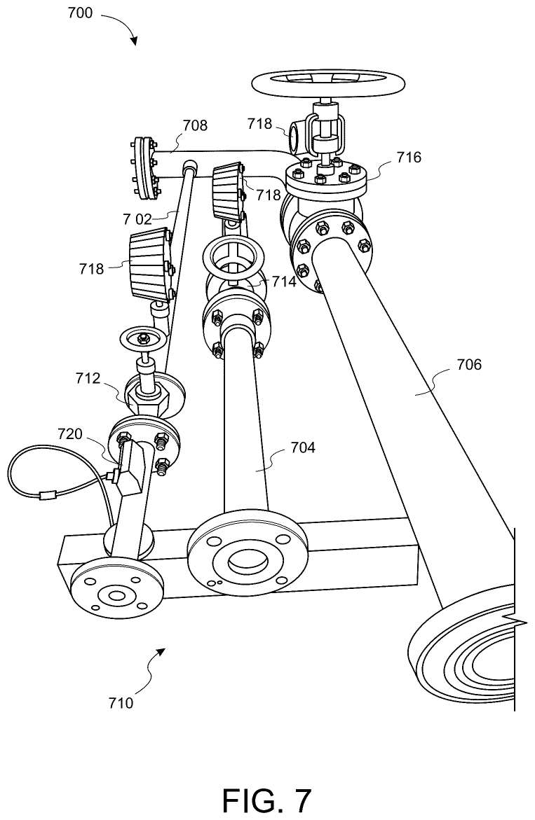

FIG. 7 is a schematic illustration of an example testing device 700 for generating training data to train the machine learning model. The testing device 700 includes 3 pipes 702-706 having different diameters. The pipes 702-706 are connected to a manifold 708 on the upstream end of the pipes. The manifold 708 is configured to distribute fluid into each pipe 702-706. The downstream ends 710 of the pipes 702-706 are open to the ambient atmosphere. The smallest diameter pipe 702 includes a gate valve 712. The medium diameter pipe 704 includes a ball valve 714. The largest diameter pipe 706 includes a globe valve 716. Each pipe 702-706 also includes a pressure sensor 718.

As shown in FIG. 7, a piezoelectric sensor 720 is magnetically attached to the pipe 702 downstream of and adjacent to the gate valve 712. The piezoelectric sensor 720 can also be magnetically attached to pipes 704 and 706 downstream of the valves 714 and 716.

The testing device 700 is operated by selecting one of the valves 712-716 for testing. The piezoelectric sensor 720 is attached to the pipe near the selected valve. The valve is configured in a chosen configuration. For example, the valve can be fully closed, partially open, or fully open. A flow of fluid is provided to the manifold 708. The fluid can be a gas (e.g., air) or a liquid (e.g., water).

A data processing system (e.g., data processing system 800) acquires training data (e.g., training data 124) from the testing device 700 by collecting acoustic emission data from the piezoelectric sensor 720 while fluid is being provided to the manifold 708. The training data includes the acoustic emission data labeled with a 0 for valves in a fully closed configuration (e.g., not passing or leaking) and labeled with a 1 for valves in a passing configuration (e.g., partially or fully open). Other labeling schemes are also possible. Including training data collected from multiple pipe diameters and multiple valve types and configurations helps prevent overfitting the machine learning model to a particular pipe size or valve type.

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user-or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### EXAMPLES

In an example implementation, a system for detecting passing valves in pipe systems in oil and gas plants includes a set of piezoelectric sensors configured to be attached to a pipe, at least a first piezoelectric sensor of the set positioned upstream of a valve and at least a second piezoelectric sensor of the set positioned downstream of the valve, the first piezoelectric sensor and the second piezoelectric sensor each configured to detect acoustic emissions from the valve; and a data processing system communicatively coupled to the set of piezoelectric sensors, the data processing system including one or more processors and a computer readable medium storing instructions that when executed cause the one or more processors to perform operations including receiving acoustic emission data from the set of piezoelectric sensors; filtering the acoustic emission data using a bandpass filter; extracting features from the filtered acoustic emission data, the extracted features including time-domain features, frequency domain features, or both; predicting an operational state of the valve using a trained machine learning model that takes as input the extracted features; and in response to predicting that the operational state of the valve is a passing valve, performing a corrective action to resolve the passing valve.

In an aspect combinable with the example implementation, the corrective action includes generating a signal to automatically close a valve upstream of the predicted passing valve.

In another aspect combinable with one, some, or all of the previous aspects, the corrective action includes generating an alert indicating the detection of the passing valve.

In another aspect combinable with one, some, or all of the previous aspects, at least a third piezoelectric sensor of the set is attached to the valve.

In another aspect combinable with one, some, or all of the previous aspects, the bandpass filter passes frequencies between 100 kHz and 300 kHz.

In another aspect combinable with one, some, or all of the previous aspects, extracting features from the acoustic emission data comprises determining one or more of a root mean square value, a spectral roll off, a spectral bandwidth, a zero-crossing rate, and Mel-Frequency Cepstral Coefficients from the acoustic emission data.

In another aspect combinable with one, some, or all of the previous aspects, the operations include combining acoustic emission data from the set of piezoelectric sensors using a weighted average wherein acoustic emission data from the second piezoelectric sensor positioned downstream of the valve receives a higher weight than acoustic emission data from the first piezoelectric sensor positioned upstream of the valve.

In another aspect combinable with one, some, or all of the previous aspects, extracting features from the acoustic emission data includes performing a cross correlation between acoustic emission data from the first piezoelectric sensor positioned upstream of the valve and acoustic emission data from the second piezoelectric sensor positioned downstream of the valve.

In another aspect combinable with one, some, or all of the previous aspects, predicting the operational state of the valve includes generating predictions using the trained machine learning model to predict the operational state of the valve based on the acoustic emission data from each piezoelectric sensor of the set separately; and combining the predictions to form a collective prediction of the operational state of the valve.

In another aspect combinable with one, some, or all of the previous aspects, extracting features from the acoustic emission data includes extracting features from the acoustic emission data for each piezoelectric sensor of the set separately; and combining the extracted features from each piezoelectric sensor of the set into a single set of extracted features.

In another aspect combinable with one, some, or all of the previous aspects, the operations include acquiring training data for the machine learning model, the training data including acoustic emission data that are labeled as being associated with passing valves and non-passing valves from a testing device, the acoustic emission data associated with multiple valve types and multiple pipe diameters; and training the machine learning model using the training data.

In another example implementation, a method for detecting passing valves includes receiving acoustic emission data from a set of piezoelectric sensors attached to a pipe with at least a first piezoelectric sensor of the set positioned upstream of a valve and at least a second piezoelectric sensor of the set positioned downstream of the valve; filtering the acoustic emission data using a bandpass filter; extracting features from the filtered acoustic emission data, the extracted features comprising time-domain features, frequency domain features, or a combination thereof derived from statistical analysis of the filtered acoustic emission data; predicting an operational state of the valve using a machine learning model that receives as input the extracted features; and in response to predicting that the operational state of the valve is a passing valve, performing a corrective action.

In an aspect combinable with the example implementation, the corrective action includes automatically closing a valve upstream of the predicted passing valve.

In another aspect combinable with one, some, or all of the previous aspects, the corrective action includes generating an alert indicating the detection of the passing valve.

In another aspect combinable with one, some, or all of the previous aspects, extracting features from the acoustic emission data includes determining one or more of a root mean square value, a spectral roll off, a spectral bandwidth, a zero-crossing rate, and Mel-Frequency Cepstral Coefficients from the acoustic emission data.

Another aspect combinable with one, some, or all of the previous aspects includes combining acoustic emission data from the set of piezoelectric sensors using a weighted average wherein acoustic emission data from the second piezoelectric sensor positioned downstream of the valve receives a higher weight than acoustic emission data from the first piezoelectric sensor positioned upstream of the valve.

In another aspect combinable with one, some, or all of the previous aspects, extracting features from the acoustic emission data includes performing a cross correlation between acoustic emission data from the first piezoelectric sensor positioned upstream of the valve and acoustic emission data from the second piezoelectric sensor positioned downstream of the valve.

In another aspect combinable with one, some, or all of the previous aspects, predicting the operational state of the valve includes generating predictions using the machine learning model to predict the operational state of the valve based on the acoustic emission data from each piezoelectric sensor of the set separately; and combining the predictions to form a collective prediction of the operational state of the valve.

In another aspect combinable with one, some, or all of the previous aspects, extracting features from the acoustic emission data includes extracting features from the acoustic emission data for each piezoelectric sensor of the set separately; and combining the extracted features from each piezoelectric sensor of the set into a single set of extracted features.

Another aspect combinable with one, some, or all of the previous aspects includes acquiring training data for the machine learning model by acquiring acoustic emission data associated with passing valves and non-passing valves from a testing device, the acoustic emission data associated with multiple valve types and multiple pipe diameters; and training the machine learning model using the training data.

What is claimed is:

1. A system for detecting passing valves in pipe systems in oil and gas plants, the system
comprising:
a set of piezoelectric sensors configured to be attached to a pipe, at least a first piezoelectric sensor of the set positioned upstream of a valve and at least a second piezoelectric sensor of the set positioned downstream of the valve, the first piezoelectric sensor and the second piezoelectric sensor each configured to detect acoustic emissions from the valve; and
a data processing system communicatively coupled to the set of piezoelectric sensors, the data processing system comprising one or more processors and a computer readable medium storing instructions that when executed cause the one or more processors to perform operations comprising:
receiving acoustic emission data from the set of piezoelectric sensors;
filtering the acoustic emission data using a bandpass filter;
extracting features from the filtered acoustic emission data, the extracted features comprising time-domain features, frequency domain features, or both;
predicting an operational state of the valve using a trained machine learning model that takes as input the extracted features; and
in response to predicting that the operational state of the valve is a passing valve, performing a corrective action to resolve the passing valve.

2. The system of claim 1, wherein the corrective action comprises generating a signal to automatically close a valve upstream of the predicted passing valve.

3. The system of claim 1, wherein the corrective action comprises generating an alert indicating the detection of the passing valve.

4. The system of claim 1, wherein at least a third piezoelectric sensor of the set is attached to the valve.

5. The system of claim 1, wherein the bandpass filter passes frequencies between 100 kHz and 300 kHz.

6. The system of claim 1, wherein extracting features from the acoustic emission data comprises determining one or more of a root mean square value, a spectral roll off, a spectral bandwidth, a zero-crossing rate, and Mel-Frequency Cepstral Coefficients from the acoustic emission data.

7. The system of claim 1, wherein the operations further comprise combining acoustic emission data from the set of piezoelectric sensors using a weighted average wherein acoustic emission data from the second piezoelectric sensor positioned downstream of the valve receives a higher weight than acoustic emission data from the first piezoelectric sensor positioned upstream of the valve.

8. The system of claim 1, wherein extracting features from the acoustic emission data comprises performing a cross correlation between acoustic emission data from the first piezoelectric sensor positioned upstream of the valve and acoustic emission data from the second piezoelectric sensor positioned downstream of the valve.

9. The system of claim 1, wherein predicting the operational state of the valve comprises:
generating predictions using the trained machine learning model to predict the operational state of the valve based on the acoustic emission data from each piezoelectric sensor of the set separately; and
combining the predictions to form a collective prediction of the operational state of the valve.

10. The system of claim 1, wherein extracting features from the acoustic emission data comprises:
extracting features from the acoustic emission data for each piezoelectric sensor of the set separately; and
combining the extracted features from each piezoelectric sensor of the set into a single set of extracted features.

11. The system of claim 1, wherein the operations further comprise:
acquiring training data for the machine learning model, the training data comprising acoustic emission data that are labeled as being associated with passing valves and non-passing valves from a testing device, the acoustic emission data associated with multiple valve types and multiple pipe diameters; and
training the machine learning model using the training data.

12. A method for detecting passing valves, the method comprising:
receiving acoustic emission data from a set of piezoelectric sensors attached to a pipe with at least a first piezoelectric sensor of the set positioned upstream of a valve and at least a second piezoelectric sensor of the set positioned downstream of the valve;
filtering the acoustic emission data using a bandpass filter;
extracting features from the filtered acoustic emission data, the extracted features comprising time-domain features, frequency domain features, or a combination thereof derived from statistical analysis of the filtered acoustic emission data;
predicting an operational state of the valve using a machine learning model that receives as input the extracted features; and
in response to predicting that the operational state of the valve is a passing valve, performing a corrective action.

13. The method of claim 12, wherein the corrective action comprises automatically closing a valve upstream of the predicted passing valve.

14. The method of claim 12, wherein the corrective action comprises generating an alert indicating the detection of the passing valve.

15. The method of claim 12, wherein extracting features from the acoustic emission data comprises determining one or more of a root mean square value, a spectral roll off, a spectral bandwidth, a zero-crossing rate, and Mel-Frequency Cepstral Coefficients from the acoustic emission data.

16. The method of claim 12, further comprising combining acoustic emission data from the set of piezoelectric sensors using a weighted average wherein acoustic emission data from the second piezoelectric sensor positioned downstream of the valve receives a higher weight than acoustic emission data from the first piezoelectric sensor positioned upstream of the valve.

17. The method of claim 12, wherein extracting features from the acoustic emission data comprises performing a cross correlation between acoustic emission data from the first piezoelectric sensor positioned upstream of the valve and acoustic emission data from the second piezoelectric sensor positioned downstream of the valve.

18. The method of claim 12, wherein predicting the operational state of the valve comprises:
generating predictions using the machine learning model to predict the operational state of the valve based on the acoustic emission data from each piezoelectric sensor of the set separately; and
combining the predictions to form a collective prediction of the operational state of the valve.

19. The method of claim 12, wherein extracting features from the acoustic emission data comprises:
extracting features from the acoustic emission data for each piezoelectric sensor of the set separately; and
combining the extracted features from each piezoelectric sensor of the set into a single set of extracted features.

20. The method of claim 12, further comprising:
acquiring training data for the machine learning model by acquiring acoustic emission data associated with passing valves and non-passing valves from a testing device, the acoustic emission data associated with multiple valve types and multiple pipe diameters; and
training the machine learning model using the training data.
